(19) United States
(12) Patent Application Publication
(10) Pub. No.: US 2014/0104242 A1
(43) Pub. Date: Apr. 17, 2014

(54) SYSTEM AND METHOD FOR CONCURRENT DISPLAY OF A VIDEO SIGNAL ON A PLURALITY OF DISPLAY DEVICES

(71) Applicant: NVIDIA CORPORATION, Santa Clara, CA (US)

(72) Inventors: Adrian Muntianu, Bellevue, WA (US); Rajat Agarwal, Santa Clara, CA (US)

(73) Assignee: Nvidia Corporation, Santa Clara, CA (US)

(21) Appl. No.: 13/650,280

(22) Filed: Oct. 12, 2012

(51) Int. Cl. G09G 5/00

(52) U.S. Cl. 345/204; 345/1.1

(57) ABSTRACT

A system and method are provided for displaying a video signal concurrently on a plurality of display devices. The system includes an operating system (OS) and a device driver. The device driver identifies a subset of display devices connected to the system, where the subset includes two or more of the display devices. The device driver also connects to the OS a virtual display device that is representative of the subset of display devices. The device driver further configures the system to route a video signal to all of the subset of display devices.

### TECHNICAL FIELD

This application is directed, in general, to display of video content from a computer and, more specifically, to concurrent display of a video signal on a plurality of display devices.

### BACKGROUND

In many applications, identical content is presented concurrently on a plurality of video displays or other video monitor devices. Such applications may include medical systems, where an x-ray, CAT scan, MRI, or other image or sequence of images (e.g., a video) is presented concurrently to a number of viewers in a plurality of locations. Such applications may also include digital signage at multiple locations in a public space. Such applications may include advertising and informational presentations in a train station or airport.

Currently, a programmer implementing such a system may be required to contend with operating system (OS) limitations on multiple displays, such as a maximum number of displays addressable by the OS. The programmer may also be required to become familiar with details and differing capabilities of individual display devices used in the system and adapt the content for display on the display devices of the system. Further, such a system may require modification when newer devices, or devices with differing capabilities, are added to an existing system.

### SUMMARY

One aspect provides a method for displaying a video signal concurrently on a plurality of display devices. The method includes identifying a subset of display devices connected to a system, where the subset includes two or more of the display devices connected to the system. The method also includes configuring the system to route a video signal to all of the subset of display devices.

Another aspect provides a system that includes an operating system (OS) and a device driver. The device driver is configured to identify a subset of display devices connected to the system, where the subset includes two or more of the display devices connected to the system. The device driver is also configured to connect to the OS a virtual display device that is representative of the subset of display devices. The device driver is further configured to configure the system to route a video signal to all of the subset of display devices.

Yet another aspect provides a non-transitory, computer readable medium that stores instructions. When executed by a processing system, the instructions cause the processing system to display a video signal concurrently on a plurality of display devices. Steps performed by the processing system include identifying a subset of display devices connected to the processing system, where the subset includes two or more of the display devices connected to the processing system. The steps also include configuring the processing system to route a video signal to all of the subset of display devices.

### BRIEF DESCRIPTION

Reference is now made to the following descriptions taken in conjunction with the accompanying drawings, in which:

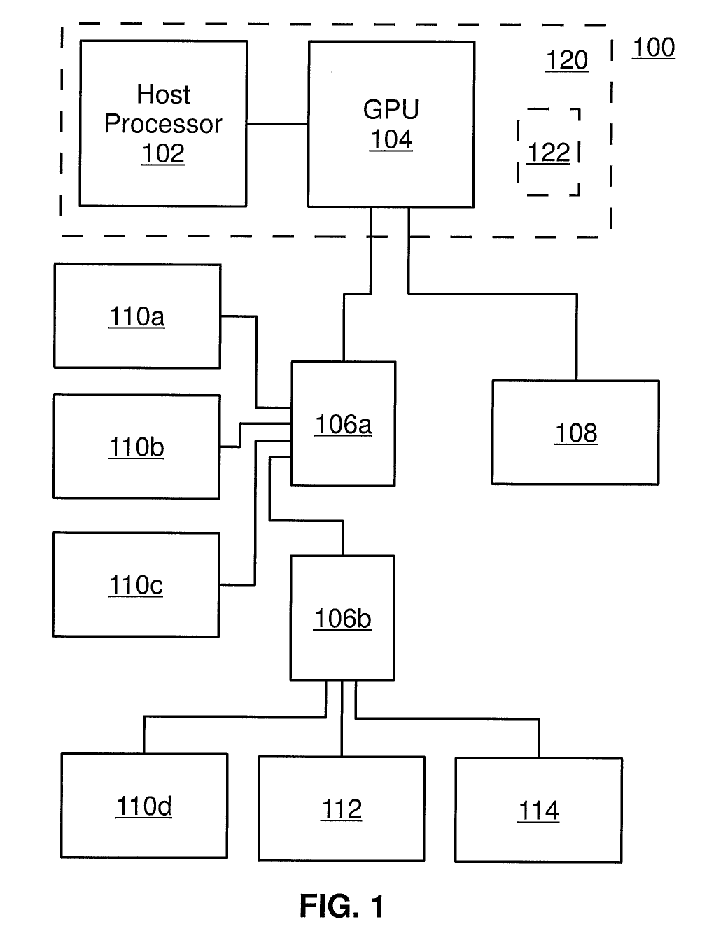

FIG. 1 is a block diagram of a processing system according to the disclosure;

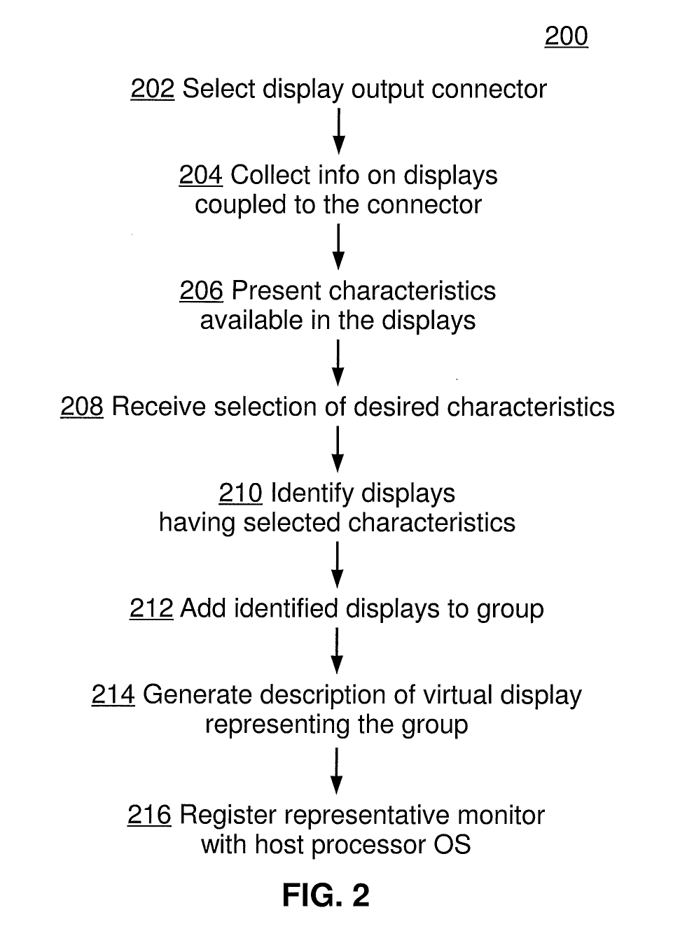

FIG. 2 is a method for creating a multi-stream clone cluster according to the disclosure;

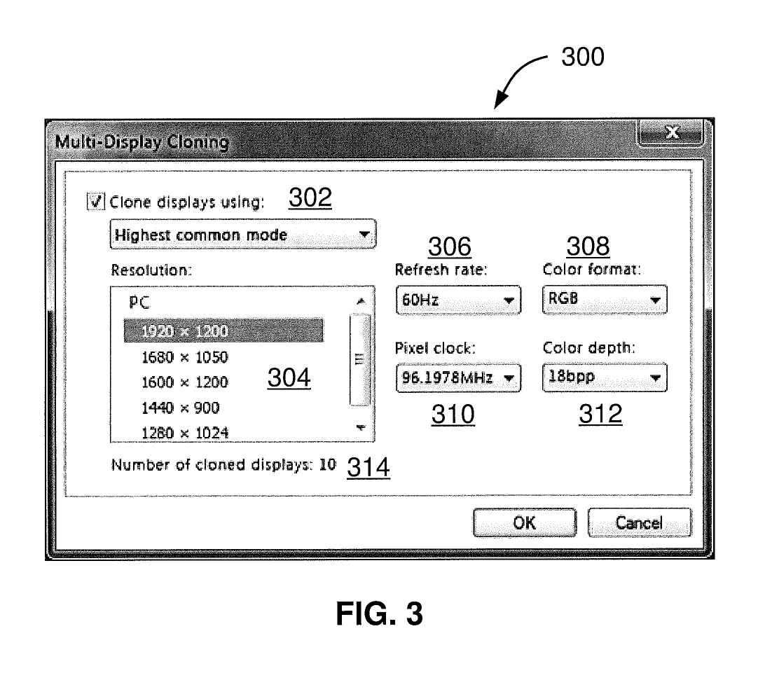

FIG. 3 is a user interface screen according to the disclosure;

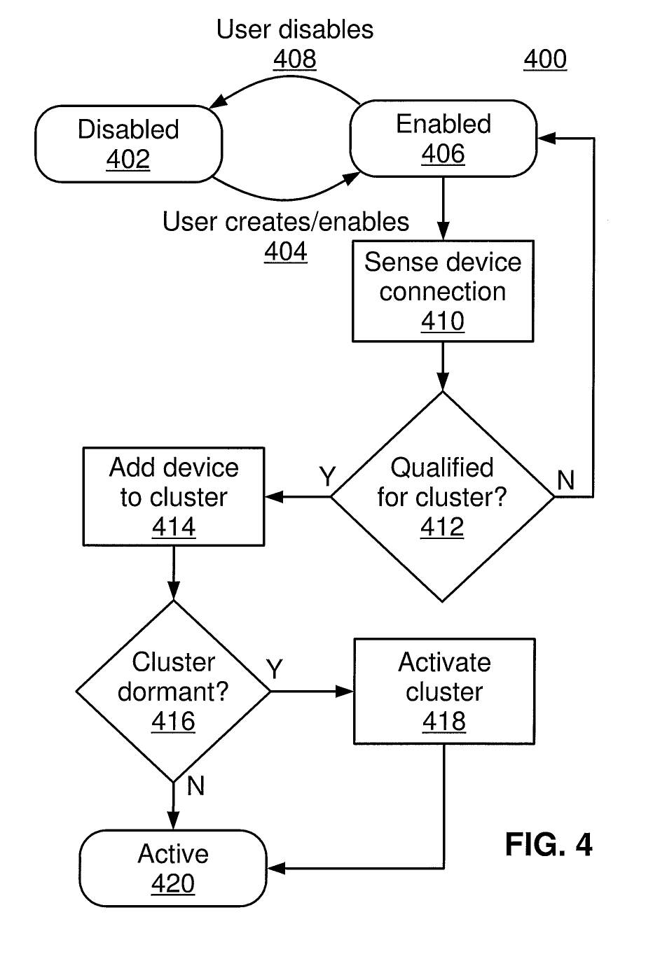

FIG. 4 is a method for responding to the connection of a display device to a system according to the disclosure;

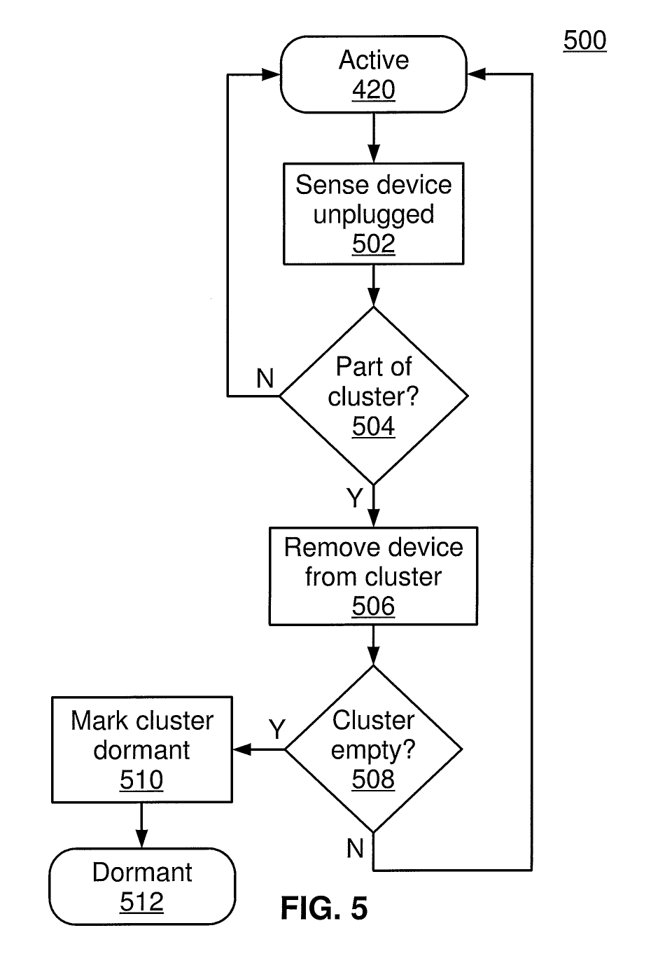

FIG. 5 is a method for responding to the disconnection of a display device from a system according to the disclosure; and

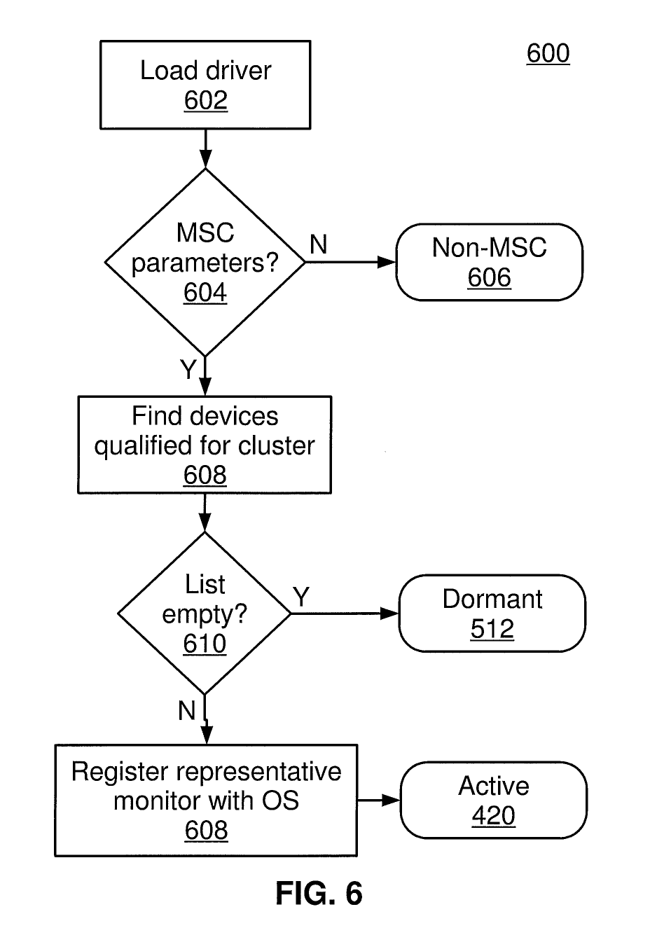

FIG. 6 is a method for loading a device driver according to the disclosure.

### DETAILED DESCRIPTION

FIG. 1 is a block diagram of a processing system 100 according to the disclosure. The system 100 includes a host processor 102 and a graphical processing unit (GPU) 104. In some embodiments, the host processor 102 is a personal computer (PC) and the GPU 104 is a card plugged into a motherboard or other circuit board of the host processor 102. In other embodiments, the GPU 104 is one of a plurality of GPUs and the host processor 102 and the GPU 104 are coupled using another suitable architecture.

The processing system 100 includes an operating system (OS) 120 that may be resident in the host processor 102, in the GPU 104, or may be distributed across the host processor 102 and one or more GPUs 104. The OS 120 includes a device driver 122 according to the disclosure, which will be described in greater detail with reference to subsequent figures.

Coupled to the GPU 104 are a branch device 106a and a display device 108. While the branch device 106a and the display device 108 are shown coupled directly to the GPU 104, in other embodiments one or both of the branch device 106a and the display device 108 may be coupled to the GPU 104 via the host processor 102 or other suitable circuit.

The branch device 106a is coupled to display devices 110a, 110b, and 110c, as well as to a branch device 106b. The branch device 106b is coupled to display devices 110d, 112, and 114. The display devices 110a, 110b, 110c, and 110d are identical devices, while the display devices 108, 112 and 114 are non-identical devices. Display devices may differ in their capabilities relating to resolution, refresh rate, color format, pixel clock, color depth, audio, and other such characteristics.

The branch device 106a is coupled to the GPU 104 via an interface providing a plurality of video signals. One example of such an interface is a DisplayPort interface, providing as many as four video lanes. The lanes form a video link which can carry up to a 63 video streams. Each stream has a unique ID and utilizes a specified amount of bandwidth on the link. Each stream has a destination, which is programmed in a table in the branch device, The branch device allocates it an appropriate time-slice of the link to each stream and forwards it accordingly. Thus, the branch device 106a may receive and distribute individual video signals to each of the display devices 110a, 110b, and 110c, and for the branch device 106b.

The branch device 106a is also adapted to duplicate any received video stream and distribute the duplicated signal to more than one of the display devices 110a, 110b, and 110c, and for the branch device 106b. When a single stream ID has multiple destinations, the branch device, under the control of the device driver 122, clones this stream and sends it out to those destinations. Every link from the GPU to each of the final monitors sees only a single copy of this stream (and therefor utilizes the bandwidth just once per stream instead of once per target monitor).

The branch device 106a is coupled to the branch device 106b via a multi-lane interface and is also adapted to distribute video streams to the branch device 106b. In other embodiments, additional branch devices may be coupled to either or both of the branch devices 106a and 106b. The branch device 106b is also adapted to distribute an individual video stream to any connected display device or branch device, or to duplicate and distribute any individual video stream to two or more connected display devices or branch devices. The branch devices 106a and 106b are adapted to distribute one or more video streams to connected devices. In some embodiments, a monitor, as a physical device, may itself incorporate a branch device, for example to provide a picture-in-picture function.

While the devices 106a and 106b are identified herein as branch devices, it will be understood that any suitable video switching device may be used to couple the GPU 104 to a plurality of display devices in a system according to the disclosure.

The host processor 102 includes one or more subsystems adapted to receive programs stored on one or more types of computer readable medium. The phrase “computer readable medium” includes any type of non-transitory medium capable of being accessed by a computer, such as read only memory (ROM), random access memory (RAM), a hard disk drive, a compact disc (CD), a digital video disc or digital versatile disc (DVD), or any other type of medium. Instructions implementing part or all of the OS 120 and/or the device driver 122 may be stored on such a computer readable medium.

A user of the processing system 100 may want to display video content concurrently on some or all of the displays 108, 110a-d, 112, and 114 (i.e., on a subset of the display devices connected to the system 100). The user employs a control panel provided by the device driver 122 to specify one or more display device characteristics. The control panel (or the device driver 122) then selects a plurality of the displays 108, 110a-d, 112, and 114 that are have at least the specified characteristic(s). This plurality of display devices is referred to herein as a multi-stream clone cluster, or more simply as a cluster.

The device driver 122 then generates a descriptor (e.g., an extended display identification data (EDID)) of a virtual display device that is representative of the cluster and registers the representative device with the OS 120, along with the display port and video stream by which the OS will send video signals to the cluster. The driver 122 also sets up one or both of the branch devices 106a and 106b as required to duplicate and distribute the video signal sent via the registered port and lane to the display devices of the cluster.

FIG. 2 is a method 200 for creating a multi-stream clone cluster of displays according to the disclosure. A user activates a control panel of the device driver 122 to begin creation of the cluster. The control panel presents the user with a dialog box (such as that shown in FIG. 2 and described below) or other user interface to use in creation of the cluster.

In step 202, a user selects a GPU display output connector through which the cluster of display devices may be sent a video signal for concurrent display. In step 204, the control panel calls the device driver 122 repeatedly to build up a list of all display devices that are coupled to the selected connector. In building the list, the device driver determines the characteristics (or capabilities) of each connected display, such as resolution, refresh rate, color format, pixel clock, color depth, audio, and other such characteristics.

In step 206, the control panel aggregates the available values for each characteristic available from the connected display devices and presents the user with those available values. In step 208, the control panel receives, via the dialog box, the user's selection of which characteristics, and what characteristic values, are desired for appropriate display of the video content that will be displayed concurrently on the devices in the cluster. Such a selection may be referred to as a “pivot.”

In step 210, the control panel (in some embodiments, with support from the device driver 122) identifies which display devices that are coupled to the selected connector are capable of providing, at a minimum, the characteristic values included in the pivot in step 208. In step 212, the identified, qualified display devices are added to a list (or “clone group”) representing the multi-stream clone cluster.

In some embodiments, prior to step 212, a listing of the identified display devices is presented to the user and the user is permitted to deselect some of the identified devices. The devices remaining in the culled list are then added to the clone group in step 212.

In step 214, the device driver 122 generates a description of a virtual display (or “representative device”) that has the characteristic values selected by the user in step 208. The representative device descriptor also has values for other characteristics that are required to fully describe a display device to the OS 120, but for which the user did not indicate a preference in step 208. Such additional characteristics will typically be given a value representing a highest quality signal that can be supported by all display devices in the display group formed in step 212. However, other value-setting heuristics may also or additionally be employed; for example, where any one of the display devices in the group is capable of audio output—and where the provision of audio output to a non-audio-capable display device does not cause problems—the representative device descriptor may indicate that the virtual device is capable of audio output.

The descriptor of the representative device generated in step 214 may be in the form of an EDID or other standardized descriptor format. In step 216, the device driver 122 registers the EDID of the representative device with the OS 120 as being coupled to the connector selected in step 202.

Where individual displays in the clone group have previously been registered with the OS 120 as being connected, before the representative device is registered with the OS 120, the device driver 122 first unregisters (or “hot unplugs”) the individual displays in the clone group from the OS 120. After registration (or “hot plugging”) of the representative device, all display devices in the clone group will receive a common video signal via the virtual representative device and the device driver 122. Individual devices in the clone group are then added to the multi-stream clone cluster, and the cluster is placed in the “active” state, as will be described in greater detail with reference to FIG. 4.

FIG. 3 is a user interface screen 300 according to the disclosure. The dialog box 300 presents the user with a preset selector 302, which will be described in greater detail below. Also presented by the interface 300 are selectors for resolution (304), refresh rate (306), color format (308), pixel clock (310) and color depth (312). Other embodiments of an interface according to the disclosure may include additional or alternative display characteristics.

The dialog box 300 provides the user with an interface to select one or more desired (or required) characteristics that are to be provided by display devices in a multi-stream clone cluster, as described with reference to step 208 of the method 200.

The preset selector 302 allows the user to select among presets that, in turn, make initial selections among the characteristic values presented in the selectors 304-312. A “common native mode” preset selects values that would form a clone group having the same native display timing. Where more than one such group exists, this preset selects values forming the largest group of displays or, where such groups are of equal size, values forming the clone group with the highest resolution.

A “highest common mode” preset selects values for the selectors 304-312 that would form a clone group having one or more common timings. Where more than one such group exists, this preset selects values forming the largest group of displays or, where such groups are of equal size, values forming the clone group with the highest timing.

If the user changes the selection in one or more of the selectors 304-312, the preset selector 302 changes to the value “custom settings.”

As described with reference to FIG. 2, the values presented to the user in the selectors 304-312 area union of all values available from the display devices that are coupled to the video output connector selected in step 202. Initially, the selected value selected in the resolution selector 304 is determined by the preset selected in the selector 302, however the user may select a different resolution.

The refresh rate (RR) selector 306 will present all available RRs for the currently selected value in the resolution selector 304, with the initial RR selection set according to the preset selected in the selector 302. Again, the user may change the RR selected in the selector 306. If the user selects a different resolution in the selector 304, the values for RR presented in the selector 306 may change accordingly.

The pixel clock selector 310 presents all available pixel clock values supported for the currently selected resolution and refresh rate. The initial pixel clock selection may be based on either the preset selected in the selector 302 or the pixel clock selection that will result in the largest clone group. Selecting a different resolution or refresh rate may change the values presented in the pixel clock selector 310.

The color format selector 308 presents all available color format values supported by the currently selected resolution, refresh rate and pixel clock. The control panel may include an order of preference amongst possible color formats and, where more than one color format is listed in the selector 308, the color format having the highest preference is initially selected.

The color depth selector 312 presents all available color depths supported by the currently selected resolution, refresh rate, pixel clock and color format. The control panel may include an order of preference amongst possible color depths and, where more than one color format is listed in the selector 308, the color depth having the highest preference is initially selected.

While particular characteristics, types of selectors, selection methodologies for values displayed in the selectors, and initial selections among the displayed values have been described and shown herein, it will be understood that in other embodiments, other characteristics, selectors, selection methodologies, and initial selections may be provided without departing from the scope of this disclosure.

As mentioned with reference to FIG. 2, when a multi-stream clone cluster is created in the processing system 100, there are display devices connected to the cluster's video output connector that are included in the cluster's clone group and the cluster is placed in the “active” state. Additionally, branch devices 104a and 104b are configured as needed to duplicate and route video signals from the cluster's video output port to the displays in the cluster.

Subsequently, all displays that are included in the cluster may be disconnected from the system 100, at which time the cluster is placed into a “dormant” state, configuration of the branch devices 104a and 104b for the cluster is reversed, and the cluster's virtual representative device is disconnected from the OS 120. The cluster is still enabled, however, and when one or more displays that qualify for inclusion in the cluster are subsequently connected to the system 100, the newly connected devices are added to the cluster, the branch devices 104a and 104b are configured according to the physical connectivity of the new devices, the cluster is returned to the “active” state, and the cluster's representative device is re-connected to the OS 120.

FIG. 4 is a method 400 for responding to the connection of a display device to a system according to the disclosure. When a display device is connected to the processing system 100 via a video output connector for which a multi-stream clone cluster has been defined, the system 100 determines whether the newly connected device has characteristics that qualify it to participate in the cluster (that is, whether it meets the criteria of the pivot) and, if so, adds the device to the cluster.

In step 404, when a user creates a multi-stream clone cluster (as described with reference to FIG. 2), the cluster is placed into the “enabled” state 406. The user may subsequently use a control panel or other user interface function in step 408 to cause the device driver 122 to place the cluster into the “disabled” state 402. Still later, the method 400 may perform step 404 again to place the “disabled” cluster back into the “enabled” state 406.

When the cluster is in the “enabled” state 406, in step 410 the device driver 122 may sense connection of a new display device to the video output port used for the cluster. In step 412, the device driver 122 determines whether the newly connected display device is qualified to participate in the cluster. If the device is not qualified, the cluster is returned to the “enabled” state 406.

If the newly connected display device is determined in step 412 to be qualified to participate in the cluster, in step 414 the device is added to the list or other data structure used to hold information about the devices included in the cluster. In step 416, the cluster's state is checked to determine whether the cluster is in the “dormant” state. If not, the cluster remains in the “active” state 420. If so, in step 418, the cluster's representative device is connected to the OS 120, one or both of the branch devices 104a and 104b are configured to route the video signal from the cluster's video output port to the newly connected device, and the cluster is placed into the “active” state 420.

FIG. 5 is a method 500 for responding to the disconnection of a display device from a system according to the disclosure. When the cluster is in the “active” state 420, the device driver 122 may sense that a display device has been “hot unplugged” or otherwise disconnected from the processing system 100. In step 504, the device driver 122 determines whether the unplugged device is included in the cluster. If not, the cluster remains in the “active” state 420.

If the unplugged device is determined in step 504 to be a member of the cluster, then in step 506 the device is removed from the cluster and configuration of the branch devices 104a and 104b is reversed that routed video signals to the newly disconnected device. In step 508, the device driver 122 determines whether the device just removed was the last device in the cluster, i.e., whether the cluster is now empty. If there are one or more devices remaining in the cluster, the cluster remains in the “active” state 420. However, if the cluster is now empty, in step 510 the cluster's representative device is disconnected from the OS 120 and the cluster is placed into the “dormant” state 512.

In the processing system 100, the definition of a cluster (e.g., its video output port, its pivot, and other defining information) persists through events such as the system 100 being powered off and back on again. More generally, the definition of a cluster persists across the device driver 122 being unloaded from the OS 120 and later reloaded.

FIG. 6 is a method 600 for loading a device driver according to the disclosure. In step 602, the device driver 122 is loaded by the OS 120. In step 604 the device driver examines its persistence database (which was stored prior to the driver 122 being unloaded) to determine whether one or more multi-stream clone (MSC) clusters were enabled when the driver 122 was last unloaded and information relating to the MSC cluster(s) stored in the persistence database. If no MSC parameters are found in the persistence database, then the driver 122 enters non-MSC operation 606.

However, if MSC parameters are found in the persistence database, in step 608 the device driver 122 reads the stored information relating to the MSC cluster(s) and identifies any display devices coupled to the cluster's video output port that meet the criteria of the cluster's pivot and are qualified to participate in the cluster. In step 610, the driver 122 determines whether the list of qualified devices is empty. If the list is empty, then the cluster is placed into the “dormant” state 512.

If the list of qualified devices is not empty, however, then in step 608 the qualified devices are added to the cluster, the branch devices 104a and 104b are configured according to the physical connectivity of the devices to duplicate and route video signals from the cluster's video output port to the qualified devices, the cluster is placed in the “active” state 420, and the cluster's representative device is connected (or “hot plugged”) to the OS 120.

Those skilled in the art to which this application relates will appreciate that other and further additions, deletions, substitutions and modifications may be made to the described embodiments.

What is claimed is:

1. A method for displaying a video signal concurrently on a plurality of display devices, the method comprising:
identifying a subset of display devices connected to a system, the subset comprising a plurality of the display devices connected to the system; and
configuring the system to route a video signal to all of the subset of display devices.

2. The method as recited in claim 1, wherein the identifying comprises:
receiving one or more display device characteristics; and
identifying the subset of display devices based upon the received one or more display device characteristics.

3. The method as recited in claim 2, wherein the receiving comprises:
determining characteristics of the display devices connected to the system; and
receiving a selection of one or more of the determined characteristics.

4. The method as recited in claim 2, further comprising:
sensing the connection of a further display device to the system;
determining characteristics of the further display device and
based upon the determined characteristics of the further display device and the received one or more display device characteristics:
adding the further display device to the subset of display devices; and
configuring the system to route the video signal to the further display device.

5. The method as recited in claim 2, further comprising storing information relating to the received one or more display device characteristics in a persistence database.

6. The method as recited in claim 1, wherein the configuring comprises configuring one or more video switching devices coupling the subset of display devices to the system.

7. The method as recited in claim 1, further comprising:
sensing a disconnection from the system of a display device in the subset of display devices;
removing the disconnected display device from the subset of display devices; and
configuring the system based upon the removal of the disconnected display device from the subset of display devices.

8. A system comprising:
an operating system (OS); and
a device driver,
wherein the device driver is configured to:
identify a subset of display devices connected to the system, the subset comprising a plurality of the display devices connected to the system;
connect to the OS a virtual display device representative of the subset of display devices; and
configure the system to route a video signal to all of the subset of display devices.

9. The system as recited in claim 8, the device driver further configured to:
receive one or more display device characteristics;
identifying the subset of display devices based upon the received one or more display device characteristics; and
characterize the virtual display device based upon characteristics of the subset of display devices.

10. The system as recited in claim 9, the device driver further configured to:
determine characteristics of the display devices connected to the system; and
receive a selection of one or more of the determined characteristics as the one or more display device characteristics.

11. The system as recited in claim 9, the device driver further configured to:
sense the connection of a further display device to the system;
determine characteristics of the further display device and
based upon the determined characteristics of the further display device and the received one or more display device characteristics:
add the further display device to the subset of display devices; and
configure the system to route the video signal to the further display device.

12. The system as recited in claim 9, the device driver further configured to:
upon being unloaded, store information relating to the received one or more display device characteristics in a persistence database; and
upon being loaded:
read the stored information;
identify a subset of display devices currently connected to the system based upon the stored information; and
configure the system to route a video signal to all of the subset of display devices currently connected to the system.

13. The system as recited in claim 8, the device driver further configured to:
sense a disconnection from the system of a display device in the subset of display devices;
remove the disconnected display device from the subset of display devices; and
configure the system based upon the removal of the disconnected display device from the subset of display devices.

14. The system as recited in claim 13, the device driver further configured to:
determine that the subset of display devices is empty; and
in response, disconnect from the OS the virtual display device.

15. A non-transitory, computer readable medium storing instructions that, when executed by a processing system, cause the processing system to display a video signal concurrently on a plurality of display devices, by performing the steps of:
identifying a subset of display devices connected to the processing system, the subset comprising a plurality of the display devices connected to the processing system; and
configuring the processing system to route a video signal to all of the subset of display devices.

16. The computer readable medium as recited in claim 15, wherein the step of identifying comprises:
receiving one or more display device characteristics; and
identifying the subset of display devices based upon the received one or more display device characteristics.

17. The computer readable medium as recited in claim 16, wherein the step of receiving comprises:
determining characteristics of the display devices connected to the system; and
receiving a selection of one or more of the determined characteristics.

18. The computer readable medium as recited in claim 16, wherein the steps further comprise:
sensing the connection of a further display device to the processing system;
determining characteristics of the further display device and
based upon the determined characteristics of the further display device and the received one or more display device characteristics:
adding the further display device to the subset of display devices; and
configuring the processing system to route the video signal to the further display device.

19. The computer readable medium as recited in claim 16, wherein the steps further comprise:
storing information relating to the received one or more display device characteristics in a persistence database

20. The computer readable medium as recited in claim 15, wherein the steps further comprise:
sensing a disconnection from the processing system of a display device in the subset of display devices;
removing the disconnected display device from the subset of display devices; and
configuring the processing system based upon the removal of the disconnected display device from the subset of display devices.
